(19) United States
(12) Patent Application Publication
(10) Pub. No.: US 2024/0007202 A1
(43) Pub. Date: Jan. 4, 2024

(54) MILLIMETER WAVE MODULE INSPECTION SYSTEM, MILLIMETER WAVE MODULE INSPECTION DEVICE, AND MILLIMETER WAVE MODULE INSPECTION METHOD

(71) Applicant: SAMSUNG ELECTRONICS CO., LTD., Suwon-si (KR)

(72) Inventors: Namjun CHO, Suwon-si (KR); Sanghun SIM, Suwon-si (KR)

(73) Assignee: SAMSUNG ELECTRONICS CO., LTD., Suwon-si (KR)

(21) Appl. No.: 18/369,601

(22) Filed: Sep. 18, 2023

Related U.S. Application Data
(63) Continuation of application No. PCT/KR22/02944, filed on Mar. 2, 2022.

(30) Foreign Application Priority Data
Mar. 18, 2021 (KR) 10-2021-0035443

(51) Int. Cl. H04B 17/19; H04B 1/38

(52) U.S. Cl. CPC H04B 17/19; H04B 1/38

(57) ABSTRACT

A millimeter wave module inspection system includes: an electronic device including at least one processor; and a millimeter wave module including a memory, at least one antenna, and at least one transceiver, wherein the at least one processor is configured to: control an input signal to be input to a transmission signal input terminal of the millimeter wave module; identify an output signal that is output from a reception signal output terminal of the millimeter wave module when the input signal passes through the at least one antenna of the millimeter wave module; identify first data corresponding to a transmission chain gain related to a transmission path of the millimeter wave module stored in the memory and second data corresponding to a reception chain gain related to a reception path of the millimeter wave module, the first data and the second data being stored in the memory; and determine whether the millimeter wave module is abnormal based at least on the identified output signal, the first data, and the second data.

### CROSS-REFERENCE TO RELATED APPLICATIONS

This application is a bypass continuation application of International Application No. PCT/KR2022/002944, filed on Mar. 2, 2022, which is based on and claims priority to Korean Patent Application No. 10-2021-0035443, filed on Mar. 18, 2021 in the Korean Intellectual Property Office, the disclosures of which are incorporated by reference herein in their entireties.

### BACKGROUND

### 1. Field

The disclosure relates to a millimeter wave module inspection system, a millimeter wave module inspection device, and a millimeter wave module inspection method.

### 2. Description of Related Art

As portable terminals providing various functions are widely used due to the development of mobile communication technology, efforts are being made to develop next-generation communication systems to meet the growing demand for wireless data traffic. For example, a next-generation communication system such as a 5G communication system is considered to be implementation in higher frequency bands (e.g., 25 to 60 GHz bands) to provide a higher data transmission rate in order to attain a higher data transmission rate, in addition to a frequency band used in a 3G communication system and a long-term evolution (LTE) communication system.

For example, in order to mitigate the path loss of radio waves and increase the propagation distance of radio waves in mmWave bands in a 5G communication system, beamforming, massive multiple-input multiple-output (MIMO), full dimensional MIMO (FD-MIMO), array antenna, analog beam-forming, and/or large scale antenna technologies are being discussed.

A standalone (SA) method and a non-standalone (NSA) method are being considered as a method of implementing 5G communication. Among them, the SA method may be a method using only a new radio (NR) system, and the NSA method may be a method using an NR system together with an existing LTE system. In the NSA scheme, a user terminal may use a gNB in an NR system, as well as an eNB in an LTE system. A technology enabling a user terminal to use heterogeneous communication systems may be referred to as dual connectivity.

5G communication technology standards may include mobile communication in the mmWave bands (e.g., 20 GHz or higher) to obtain a higher transmission rate than the existing 4G. A front end structure in which an array antenna and a transceiver are integrated into one module may be adopted to support the mmWave bands, which may be referred to as a millimeter wave (mmWave) module.

Since the millimeter wave module is manufactured in an antenna-in-package (AiP) form in which an antenna and a radio frequency integrated circuit (RFIC) are integrated, it is impossible to make a separate external connection port for measuring the performance of the RFIC itself excluding the antenna.

A determination of whether the RFIC performance is good or bad (hereinafter referred to as “defect inspection” or “malfunction test”) may be performed by forming a self-loopback path using an H-pole and V-pole of a patch antenna. While the method using a self-loopback path has the advantage of effectively reducing space, compared to a far-field loopback method using an inspection chamber, detection capability thereof may be relatively low.

### SUMMARY

One or more embodiments, in order to prevent the degradation of detection capability in the method using a self-loopback path, may provide a millimeter wave module inspection system, a millimeter wave module inspection device, and a millimeter wave module inspection method of storing a TX chain gain and an RX chain gain measured during inspection of an RFIC in a wafer form in a memory of the RFIC and using the same when inspecting RFIC defects after manufacturing the millimeter wave module.

According to an aspect of the disclosure, a millimeter wave module inspection system including: an electronic device including at least one processor; and a millimeter wave module including a memory, at least one antenna, and at least one transceiver, wherein the at least one processor is configured to: control an input signal to be input to a transmission signal input terminal of the millimeter wave module; identify an output signal that is output from a reception signal output terminal of the millimeter wave module when the input signal passes through the at least one antenna of the millimeter wave module; identify first data corresponding to a transmission chain gain related to a transmission path of the millimeter wave module stored in the memory and second data corresponding to a reception chain gain related to a reception path of the millimeter wave module, the first data and the second data being stored in the memory; and determine whether the millimeter wave module is abnormal based at least on the identified output signal, the first data, and the second data.

At least one of the first data or the second data may include data measured in a process of manufacturing a radio frequency integrated circuit included in the millimeter wave module.

The at least one processor may be further configured to: identify a coupling factor of an antenna of the millimeter wave module, based at least on the identified output signal, the first data, and the second data; and determine whether the millimeter wave module is abnormal based on the identified coupling factor.

The at least one processor may be further configured to determine whether the millimeter wave module is abnormal based at least on a signal detected at an output terminal of a power amplifier included in a transmission circuit of the millimeter wave module.

The at least one processor may be further configured to control a reference clock for generating a local oscillator frequency used in the millimeter wave module to be input to the transmission signal input terminal of the millimeter wave module.

According to an aspect of the disclosure, an electronic device includes: a communication interface; a memory storing instructions; and at least one processor operatively connected to the communication interface and the memory, wherein the at least one processor is configured to execute the instructions to: transmit, through the communication interface, an input signal to a transmission signal input terminal of a millimeter wave module including at least one antenna and at least one transceiver; receive, through the communication interface, an output signal that is output from a reception signal output terminal of the millimeter wave module when the input signal passes through the at least one antenna of the millimeter wave module; identify first data corresponding to a transmission chain gain related to a transmission path of the millimeter wave module stored in a memory of the millimeter wave module and second data corresponding to a reception chain gain related to a reception path of the millimeter wave module, the first data and the second data being stored in the memory of the millimeter wave module; and determine whether the millimeter wave module is abnormal based at least on the identified output signal, the first data, and the second data.

At least one of the first data or the second data may include data measured in a process of manufacturing a radio frequency integrated circuit included in the millimeter wave module.

The at least one processor may be further configured to: identify a coupling factor of an antenna of the millimeter wave module, based at least on the identified output signal, the first data, and the second data; and determine whether the millimeter wave module is abnormal based on the identified coupling factor.

The at least one processor may be further configured to determine whether the millimeter wave module is abnormal based at least on a signal detected at an output terminal of a power amplifier included in a transmission circuit of the millimeter wave module.

The at least one processor may be further configured to control a reference clock for generating a local oscillator frequency used in the millimeter wave module to be input to the transmission signal input terminal of the millimeter wave module.

According to an aspect of the disclosure, a millimeter wave module inspection method includes: inputting an input signal to a transmission signal input terminal of a millimeter wave module; identifying an output signal that is output from a reception signal output terminal of the millimeter wave module when the input signal passes through at least one antenna of the millimeter wave module; identifying first data corresponding to a transmission chain gain related to a transmission path of the millimeter wave module stored in a memory of the millimeter wave module and second data corresponding to a reception chain gain related to a reception path of the millimeter wave module, the first data and the second data being stored in the memory of the millimeter wave module; and determining whether the millimeter wave module is abnormal based at least on the identified output signal, the first data, and the second data.

At least one of the first data or the second data may include data measured in a process of manufacturing a radio frequency integrated circuit included in the millimeter wave module.

The millimeter wave module inspection method may further include: identifying a coupling factor of an antenna of the millimeter wave module, based at least on the identified output signal, the first data, and the second data; and determining whether the millimeter wave module is abnormal based on the identified coupling factor.

The millimeter wave module inspection method may further include determining whether the millimeter wave module is abnormal based at least on a signal detected at an output terminal of a power amplifier included in a transmission circuit of the millimeter wave module.

The millimeter wave module inspection method may further include inputting a reference clock for generating a local oscillator frequency used in the millimeter wave module to the transmission signal input terminal of the millimeter wave module.

According to one or more embodiments, a TX chain gain and an RX chain gain measured when inspecting an RFIC in a wafer form may be stored in a memory of the RFIC and the defects of the RFIC may be inspected using data stored in the memory after manufacturing the millimeter wave module, thereby improving detection capability in a method using a self-loopback path.

According to one or more embodiments, manufacturing costs may be reduced and manufacturing space may be efficiently used by not using expensive equipment and far-fields for determining module defects in a millimeter wave module manufacturing line.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an electronic device in a network environment, according to various embodiments;

FIG. 2A is a block diagram of an electronic device in a network environment including a plurality of cellular networks, according to an embodiment of the disclosure;

FIG. 2B is a block diagram of an electronic device in a network environment including a plurality of cellular networks, according to another embodiment of the disclosure;

FIGS. 3A, 3B, and 3C illustrate a structure of an antenna module, according to an embodiment of the disclosure;

FIG. 4 is a block diagram of an electronic device including an antenna module, according to an embodiment of the disclosure;

FIG. 5 is a block diagram of an IFIC, according to an embodiment of the disclosure;

FIG. 6 illustrates an RFIC and antenna module, according to an embodiment of the disclosure;

FIG. 7 illustrates a self-loopback inspection system, according to an embodiment of the disclosure;

FIG. 8A illustrates a TX chain inside a millimeter wave module, according to embodiment of the disclosure;

FIG. 8B illustrates an RX chain inside a millimeter wave module, according to embodiment of the disclosure;

FIG. 8C illustrates a frequency synthesizer inside a millimeter wave module, according to an embodiment of the disclosure;

FIG. 8D illustrates an antenna inside a millimeter wave module, according to an embodiment of the disclosure;

FIG. 9 illustrates an example mis-determinable section in a far-field loopback inspection, according to an embodiment of the disclosure;

FIG. 10 illustrates a self-loopback inspection system, according to an embodiment of the disclosure;

FIG. 11 illustrates an example mis-determinable section in a self-loopback inspection, according to an embodiment of the disclosure;

FIG. 12 is a diagram illustrating a data flow of a method for obtaining a TX chain gain and an RX chain gain of an RFIC, according to an embodiment of the disclosure;

FIG. 13 illustrates a self-loopback inspection system, according to another embodiment of the disclosure;

FIG. 14 illustrates an example mis-determinable section in a self-loopback inspection, according to an embodiment of the disclosure;

FIG. 15 is a flowchart illustrating a method of inspecting a millimeter wave module by an electronic device, according to an embodiment of the disclosure;

FIG. 16 is a sequence diagram illustrating an method of inspecting a millimeter wave module by an electronic device, according to an embodiment of the disclosure;

FIG. 17 is a flowchart illustrating a method of inspecting a millimeter wave module by an electronic device, according to another embodiment of the disclosure; and

FIG. 18 is a flowchart illustrating a method of inspecting a millimeter wave module by an electronic device, according to yet another embodiment of the disclosure.

### DETAILED DESCRIPTION

Hereinafter, embodiments of the disclosure will be described in detail with reference to the attached drawings.

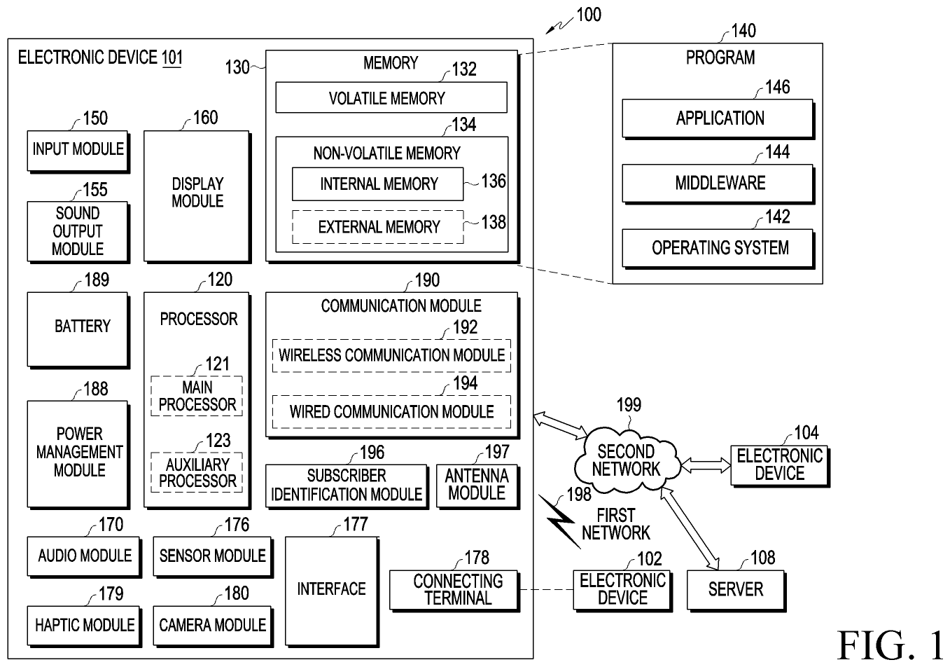

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

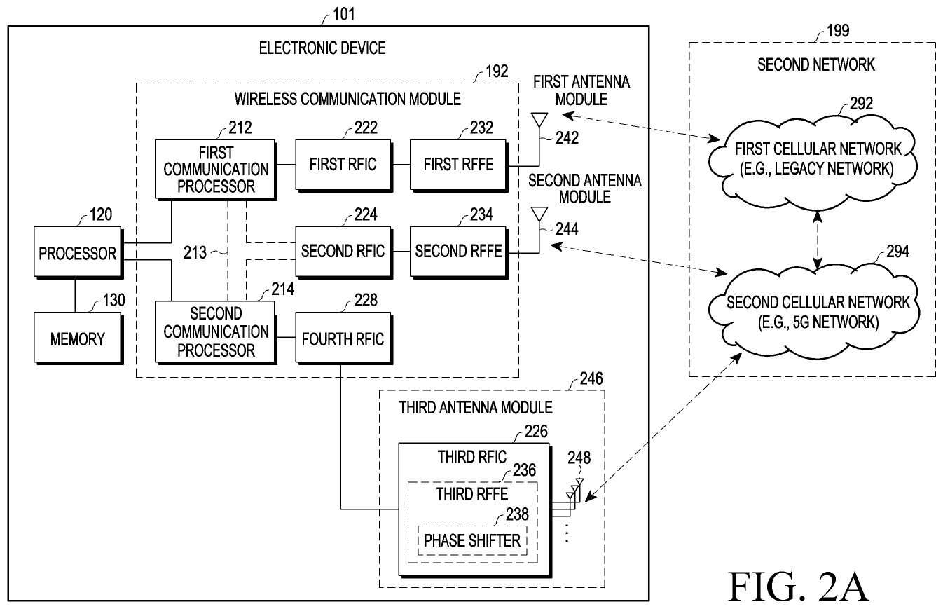

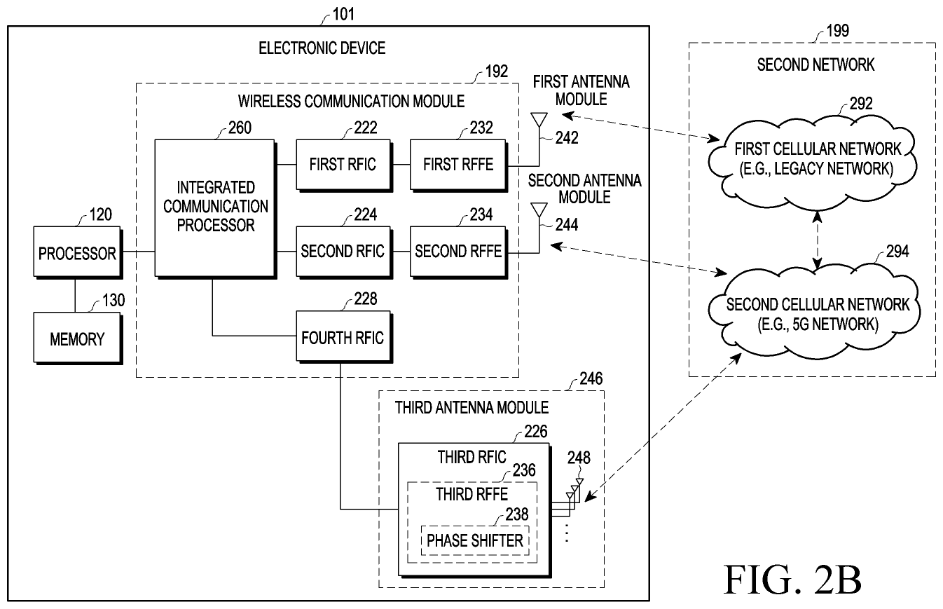

FIG. 2A is a block diagram of an electronic device 101 in a network environment including a plurality of cellular networks, according to an embodiment of the disclosure. Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include a processor 120 and a memory 130. The second network 199 may include a first cellular network 292 and a second cellular network 294. According to another embodiment, the electronic device 101 may further include at least one of the elements shown in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may constitute at least a part of the wireless communication module 192. According to another embodiment, the fourth RFIC 228 may be omitted or included as a part of the third RFIC 226.

The first communication processor 212 may support establishment of a communication channel in a band to be used for wireless communication with the first cellular network 292 and legacy network communication through the established communication channel. According to an embodiment, the first cellular network may be a legacy network including a second generation (2G), 3G, 4G, or long-term evolution (LTE) network. The second communication processor 214 may support establishment of a communication channel corresponding to a designated band (e.g., about 6 GHz to about 60 GHz) among bands to be used for wireless communication with the second cellular network 294 and 5G network communication through the established communication channel. According to an embodiment, the second cellular network 294 may be a 5G network defined in 3GPP. Additionally, according to an embodiment, the first communication processor 212 or the second communication processor 214 may support establishment of a communication channel corresponding to another designated band (e.g., about 6 GHz or less) among bands to be used for wireless communication with the second cellular network 294 and 5G network communication through the established communication channel. According to an embodiment, the first communication processor 212 and the second communication processor 214 may be implemented in a single chip or single package. According to an embodiment, the first communication processor 212 or the second communication processor 214 may be provided in a single chip or single package along with the processor 120, the auxiliary processor 123, or the communication module 190. According to an embodiment, the first communication processor 212 and the second communication processor 214 may be directly or indirectly connected to each other by an interface 213 to provide or receive data or control signals unidirectionally or bidirectionally.

Depending on the implementation, the first communication processor 212 need not be directly connected to the second communication processor 214. In this case, the first communication processor 212 may transmit and receive data to and from the second communication processor 214 through the processor 120 (e.g., an application processor). For example, the first communication processor 212 and the second communication processor 214 may transmit and receive data to and from the processor 120 (e.g., application processor) through an HS-UART interface or a PCIe interface, but the type of interface is not limited. Alternatively, the first communication processor 212 and the second communication processor 214 may exchange control information and packet data information with the processor 120 (e.g., an application processor) using a shared memory.

According to an embodiment, the first communication processor 212 and the second communication processor 214 may be implemented in a single chip or single package. According to an embodiment, the first communication processor 212 or the second communication processor 214 may be provided in a single chip or single package along with the processor 120, the auxiliary processor 123, or the communication module 190. For example, as shown in another embodiment illustrated in FIG. 2B, a unified communication processor 260 may support all functions for communication with both the first cellular network and the second cellular network.

In the case of transmission, the first RFIC 222 may convert a baseband signal generated by the first communication processor 212 into a radio frequency (RF) signal of about 700 MHz to about 3 GHz used in the first cellular network 292 (e.g., a legacy network). In the case of reception, an RF signal may be obtained from the first cellular network 292 (e.g., a legacy network) through an antenna (e.g., the first antenna module 242) and preprocessed by an RFFE (e.g., the first RFFE 232). The first RFIC 222 may convert the preprocessed RF signal into a baseband signal so as to be processed by the first communication processor 212.

In the case of transmission, the second RFIC 224 may convert a baseband signal generated by the first communication processor 212 or the second communication processor 214 into an RF signal (hereinafter, a 5G Sub6 RF signal) in a Sub6 band (e.g., about 6 GHz or less) used in the second cellular network 294 (e.g., a 5G network). In the case of reception, a 5G Sub6 RF signal may be obtained from the second cellular network 294 (e.g., a 5G network) through an antenna (e.g., the second antenna module 244) and preprocessed by an RFFE (e.g., the second RFFE 234). The second RFIC 224 may convert the preprocessed 5G Sub6 RF signal into a baseband signal so as to be processed by a corresponding communication processor among the first communication processor 212 and the second communication processor 214.

The third RFIC 226 may convert a baseband signal generated by second communication processor 214 into an RF signal (hereinafter, a 5G Above6 RF signal) in a 5G Above6 band (e.g., about 6 GHz to about 60 GHz) to be used in the second cellular network 294 (e.g., a 5G network). In the case of reception, a 5G Above6 RF signal may be obtained from the second cellular network 294 (e.g., a 5G network) through an antenna (e.g., the antenna 248) and preprocessed by a third RFFE 236. The third RFIC 226 may convert the preprocessed 5G Above6 RF signal into a baseband signal so as to be processed by the second communication processor 214. According to an embodiment, the third RFFE 236 may be configured as a part of the third RFIC 226.

The electronic device 101, according to an embodiment, may include a fourth RFIC 228 separately from or at least as a part of the third RFIC 226. In this case, the fourth RFIC 228 may convert a baseband signal generated by the second communication processor 214 into an RF signal (hereinafter, IF signal) in an intermediate frequency band (e.g., about 9 GHz to about 11 GHz) and then transmit the IF signal to the third RFIC 226. The third RFIC 226 may convert the IF signal into a 5G Above6 RF signal. In the case of reception, a 5G Above6 RF signal may be received from the second cellular network 294 (e.g., a 5G network) through an antenna (e.g., the antenna 248) and converted into an IF signal by the third RFIC 226. The fourth RFIC 228 may convert the IF signal into a baseband signal so as to be processed by the second communication processor 214.

According to an embodiment, the first RFIC 222 and the second RFIC 224 may be implemented as a single chip or at least part of a single package. According to an embodiment, the first RFFE 232 and the second RFFE 234 may be implemented as a single chip or at least part of a single package. According to an embodiment, at least one of the first antenna module 242 and the second antenna module 244 may be omitted or combined with another antenna module to process RF signals in a plurality of bands.

According to an embodiment, the third RFIC 226 and the antenna 248 may be disposed on the same substrate to form a third antenna module 246. For example, the wireless communication module 192 or the processor 120 may be disposed on a first substrate (e.g., a main PCB). In this case, the third RFIC 226 may be disposed in a partial area (e.g., a lower surface) of a second substrate (e.g., a sub-PCB), which is separate from the first substrate, and the antenna 248 is disposed in another partial area (e.g., an upper surface) thereof, thereby configuring the third antenna module 246. By disposing the third RFIC 226 and the antenna 248 on the same substrate, it is possible to reduce the length of a transmission line therebetween. This, for example, may reduce loss (e.g., attenuation) of a signal in a high-frequency band (e.g., about 6 GHz to about 60 GHz) used in 5G network communication due to a transmission line. As a result, the electronic device 101 may improve the quality or speed of communication with the second cellular network 294 (e.g., a 5G network).

According to an embodiment, the antenna 248 may be configured as an array antenna including a plurality of antenna elements that may be used for beamforming. In this case, the third RFIC 226 may include, for example, a plurality of phase shifters 238 corresponding to a plurality of antenna elements as a part of the third RFFE 236. In the case of transmission, each of the plurality of phase shifters 238 may convert the phase of a 5G Above6 RF signal to be transmitted to the outside of the electronic device 101 (e.g., a base station in a 5G network) through a corresponding antenna element. In the case of reception, each of the plurality of phase shifters 238 may convert the phase of the 5G Above6 RF signal received from the outside through the corresponding antenna element into the same or substantially the same phase. This enables transmission or reception through beamforming between the electronic device 101 and the outside.

The second cellular network 294 (e.g., a 5G network) may be operated independently (e.g., standalone (SA)) of the first cellular network 292 (e.g., a legacy network) or operated while being connected thereto (e.g., non-standalone (NSA)). For example, a 5G network may include only an access network (e.g., a 5G radio access network (RAN) or a next-generation RAN (NG RAN)) and may omit a core network (e.g., a next-generation core (NGC)). In this case, after accessing an access network of the 5G network, the electronic device 101 may access an external network (e.g., the Internet) under the control of a core network (e.g., evolved packed core (EPC)) of the legacy network. Protocol information (e.g., LTE protocol information) for communication with the legacy network or protocol information (e.g., new radio (NR) protocol information) for communication with the 5G network may be stored in the memory 130 and accessed by other components (e.g., the processor 120, the first communication processor 212, or the second communication processor 214).

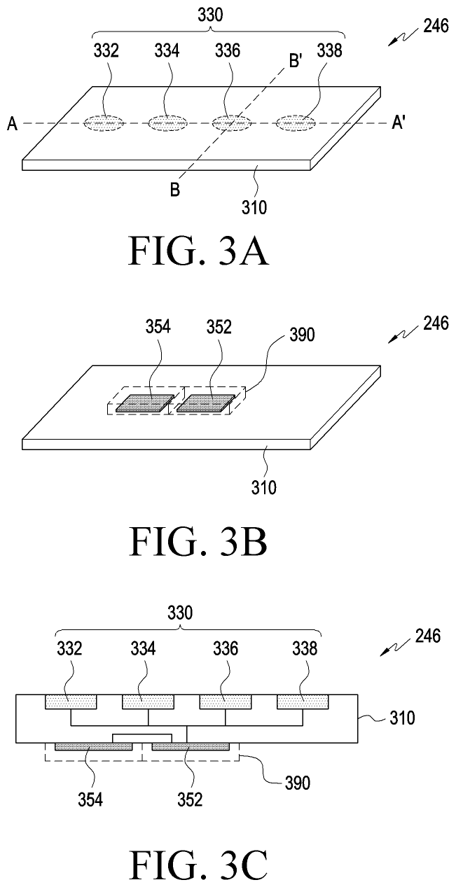

FIGS. 3A, 3B, and 3C illustrate a structure of the third antenna module 246 described, for example, with reference to FIGS. 2A and 2B, according to an embodiment of the disclosure. FIG. 3A is a perspective view of the third antenna module 246 viewed from one side, FIG. 3B is a perspective view of the third antenna module 246 viewed from the other side, and FIG. 3C is a cross-sectional view of the third antenna module 246 taken along line A-A′.

Referring to FIGS. 3A, 3B, and 3C, in an embodiment, the third antenna module 246 may include a printed circuit board 310, an antenna array 330, a radio frequency integrates circuit (RFIC) 352, or a power manage integrate circuit (PMIC) 354. Optionally, the third antenna module 246 may further include a shielding member 390. In other embodiments, at least one of the aforementioned components may be omitted or at least two of the components may be integrally formed.

The printed circuit board 310 may include a plurality of conductive layers and a plurality of non-conductive layers alternately stacked with the conductive layers. The printed circuit board 310 may provide an electrical connection between the printed circuit board 310 and/or various electronic components disposed on the outside using wires and conductive vias formed on the conductive layer.

The antenna array 330 (e.g., 248 in FIG. 2A) may include a plurality of antenna elements 332, 334, 336, or 338 arranged to form directional beams. The antenna elements may be formed on a first surface of the printed circuit board 310 as shown. According to another embodiment, the antenna array 330 may be formed inside the printed circuit board 310. According to embodiments, the antenna array 330 may include a plurality of antenna arrays (e.g., dipole antenna arrays and/or patch antenna arrays) in the same or different shapes or types.

The RFIC 352 (e.g., 226 in FIG. 2A) may be disposed on another area of the printed circuit board 310 (e.g., on a second surface opposite the first surface), which is spaced apart from the antenna array 330. The RFIC may be configured to process signals in a selected frequency band, which are transmitted/received through the antenna array 330. According to an embodiment, the RFIC 352 may convert a baseband signal obtained from a communication processor (not shown) into an RF signal in a designated band during transmission. The RFIC 352, upon reception, may convert an RF signal received through the antenna array 330 into a baseband signal and transmit the same to the communication processor (e.g., the second communication processor 214 in FIG. 2A or the unified communication processor 260 in FIG. 2B).

According to another embodiment, the RFIC 352, during transmission, may up-convert an IF signal (e.g., about 9 GHz to about 11 GHz) obtained from an intermediate frequency integrate circuit (IFIC) (e.g., the fourth RFIC 228 in FIG. 2A) into an RF signal in a selected band. The RFIC 352, upon reception, may down-convert an RF signal obtained through the antenna array 330 into an IF signal and transmit the same to the IFIC.

The PMIC 354 may be disposed in another partial area (e.g., the second surface) of the printed circuit board 310, which is spaced apart from the antenna array. The PMIC may receive voltage supplied from a main PCB (not shown) and provide power used by various components (e.g., the RFIC 352) on the antenna module.

The shielding member 390 may be disposed on a portion (e.g., the second surface) of the printed circuit board 310 to electromagnetically shield at least one of the RFIC 352 and the PMIC 354. According to an embodiment, the shielding member 390 may include a shield can.

Although not shown, in an embodiment, the third antenna module 246 may be electrically connected to another printed circuit board (e.g., a main circuit board) through a module interface. The module interface may include a connecting member, for example, a coaxial cable connector, a board-to-board connector, an interposer, or a flexible printed circuit board (FPCB). The RFIC 352 and/or the PMIC 354 of the antenna module may be electrically connected to the printed circuit board through the connection member.

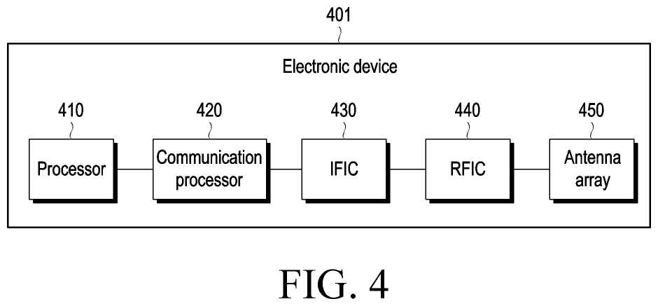

FIG. 4 is a block diagram of an electronic device including an antenna module, according to an embodiment of the disclosure. An electronic device 401 (e.g., the electronic device 101 in FIG. 1) may include a processor 410, a communication processor 420, an IFIC 430, an RFIC 440, and/or an antenna array 450. According to an embodiment, the RFIC 440 and the antenna array 450 may be included in an antenna module. For a brief description, among the elements included in the electronic device 401, the remaining elements excluding the processor 410, the communication processor 420, the IFIC 430, the RFIC 440, and the antenna array 450 are omitted from FIG. 4. According to an embodiment, the processor 410 may be the processor 120 in FIG. 1. According to an embodiment, the communication processor 420 may be the second communication processor 214 in FIG. 2A or the unified communication processor 260 in FIG. 2B. According to an embodiment, the IFIC 430 may be the fourth RFIC 228 in FIG. 2A or 2B. According to an embodiment, the RFIC 440 may be the third RFIC 226 in FIG. 2A or 2B. According to an embodiment, the antenna array 450 may be the antenna 248 in FIG. 2A or 2B. According to an embodiment, the antenna array 450 may include at least one antenna element (e.g., a plurality of antenna elements 332, 334, 336, or 338 shown in FIGS. 3A, 3B, and 3C).

According to an embodiment, the communication processor 420 may generate a baseband signal, based on a control signal from the processor 410. The baseband signal generated by the communication processor 420 may be transferred to the IFIC 430. The IFIC 430 may transmit one or more signals in an intermediate frequency band to the RFIC 440, based on the baseband signal.

According to an embodiment, the intermediate-frequency signal transferred from the IFIC 430 to the RFIC 440 may include at least one of a first intermediate-frequency (IF) signal (hereinafter, referred to as a “first IF signal”) corresponding to at least one antenna (e.g., a V-pole antenna) radiating a first polarization characteristic signal and a second intermediate-frequency signal (hereinafter, referred to as a “second IF signal”) corresponding to at least one antenna (e.g., an H-pole antenna) radiating a second polarization characteristic signal. According to an embodiment, an interface (e.g., port) for transmitting the first IF signal and an interface (e.g., port) for transmitting the second IF signal may be separately arranged between the IFIC 430 and the RFIC 440.

According to an embodiment, the first IF signal output from the IFIC 430 may be converted into a first RF signal by the RFIC 440, and the first RF signal may be radiated as a signal having the first polarization characteristic through at least one V-pole antenna of the antenna array 450. The second IF signal output from the IFIC 430 may be converted into a second RF signal by the RFIC 440, and the second RF signal may be may be radiated as a signal having the second polarization characteristic through at least one H-pole antenna of the antenna array 450.

According to an embodiment, having the first polarization characteristic may indicate having an electric field polarized in a direction perpendicular to the ground, and having the second polarization characteristic may indicate having an electric field polarized in a direction horizontal to the ground, but the disclosure is not limited thereto.

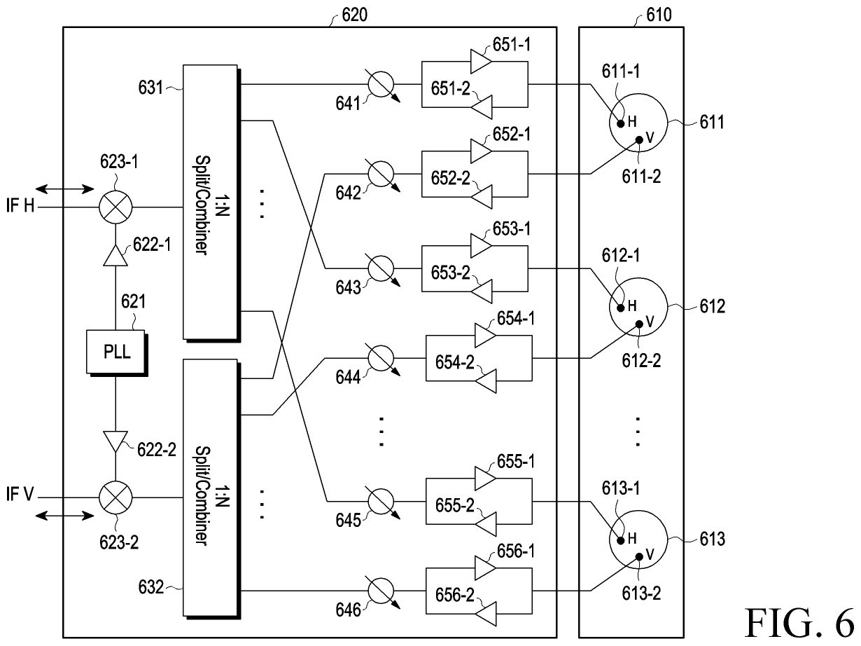

According to an embodiment, the RFIC 440 (e.g., the third RFIC 226 in FIG. 2A) and the antenna array 450 (e.g., the antenna 248 in FIG. 2A) may be disposed on the same substrate to configure a single module (for example, a millimeter wave module (e.g., the third antenna module 246 in FIG. 2A)), and a detailed example thereof will be described later with reference to FIG. 6.

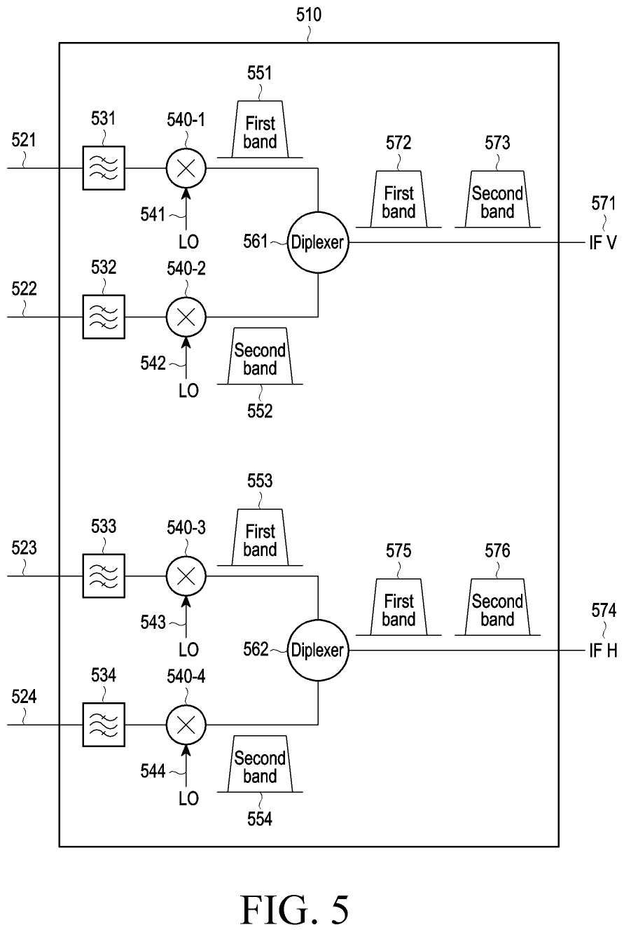

FIG. 5 is a block diagram of an IFIC, according to an embodiment of the disclosure. According to an embodiment, an IFIC 510 may include a plurality of bandpass filters 531, 532, 533, and/or 534, a plurality of mixers 540-1, 540-2, 540-3, and 540-4, or a plurality of diplexers 561 and/or 562.

According to an embodiment, the IFIC 510 may receive a baseband signal generated by a communication processor (e.g., the communication processor 420) through a port 521. The signal received through the port 521 may pass through the bandpass filter 531, which passes a designated baseband frequency component, and the frequency of the signal passing through the bandpass filter 531 may be converted into a first band (e.g., 8 GHz) by a local oscillator 541 through the mixer 540-1 and then be input to the diplexer 561. Here, the signal output from the bandpass filter 531 may be referred to as a first baseband signal.

According to an embodiment, the IFIC 510 may receive a baseband signal generated by a communication processor (e.g., the communication processor 420) through a port 522. The signal received through the port 522 may pass through the bandpass filter 532, which is different from the bandpass filter 531 and passes a designated baseband frequency component, and the frequency of the signal passing through the bandpass filter 532 may be converted into a second band (e.g., 10.5 GHz) by a local oscillator 542 through the mixer 540-2 and then be input to the diplexer 561. Here, the signal output from the bandpass filter 532 may be referred to as a second baseband signal.

According to an embodiment, the diplexer 561 may synthesize a signal 551 whose frequency was converted to a first band (e.g., 8 GHz) by the local oscillator 541 and a signal 552 whose frequency is converted to a second band (e.g., 10.5 GHz) by the local oscillator 542, and output the synthesized signal. The signal output from the diplexer 561 may be referred to as a first IF signal 571 and may include a first IF component 572 having a first frequency and a second IF component 573 having a second frequency.

According to an embodiment, the IFIC 510 may receive a baseband signal generated by a communication processor (e.g., the communication processor 420) through a port 523. The signal received through the port 523 may pass through the bandpass filter 533, which passes a designated baseband frequency component, and the frequency of the signal passing through the bandpass filter 533 may be converted into a first band (e.g., 8 GHz) by a local oscillator 543 through the mixer 540-3 and then be input to the diplexer 562. Here, the signal output from the bandpass filter 533 may be referred to as a third baseband signal.

According to an embodiment, the IFIC 510 may receive a baseband signal generated by a communication processor (e.g., the communication processor 420) through a port 524. The signal received through the port 524 may pass through the bandpass filter 534, which is different from the bandpass filter 533 and passes a designated baseband frequency component, and the frequency of the signal passing through the bandpass filter 534 may be converted into a second band (e.g., 10.5 GHz) by a local oscillator 544 through the mixer 540-4 and then be input to the diplexer 562. Here, the signal output from the bandpass filter 534 may be referred to as a fourth baseband signal.

According to an embodiment, the diplexer 562 may synthesize a signal 553 whose frequency was converted to a first band (e.g., 8 GHz) by the local oscillator 543 and a signal 554 whose frequency is converted to a second band (e.g., 10.5 GHz) by the local oscillator 544, and output the synthesized signal. The signal output from the diplexer 562 may be referred to as a second IF signal 574 and may include a third IF component 575 having a first frequency and a fourth IF component 576 having a second frequency.

According to an embodiment, the IFIC 510 may include a frequency converter (e.g., a mixer). For example, the IFIC 510 may convert the frequency of a signal received through the port (e.g., 521, 522, 523, and/or 524) using a frequency converter (e.g., a mixer). According to an embodiment, the diplexers 561 and/or 562 may include a triplexer. For example, the IFIC 510 may include a plurality of bandpass filters 531, 532, 533, and/or 534, and a plurality of mixers 540-1, 540-2, 540-3, and/or 540-4, or a plurality of triplexers.

FIG. 6 illustrates an RFIC and antenna module, according to an embodiment of the disclosure. Referring to FIG. 6, a millimeter wave module (e.g., the antenna module 197 in FIG. 1 or the third antenna module 246 in FIG. 2A or 2B) may include an RFIC 620 and an antenna array 610. According to an embodiment, the RFIC 620 may include a PLL 621, amplifiers 622-1 and 622-2, a first mixer 623-1, a second mixer 623-2, a first splitter/combiner 631, a second splitter/combiner 632, a plurality of phase shifters 641, 642, 643, 644, 645, and/or 646, a plurality of power amplifiers (PAs) 651-1, 652-1, 653-1, 654-1, 655-1, and/or 656-1, and/or a plurality of low-noise amplifiers (LNAs) 651-2, 652-2, 653-2, 654-2, 655-2, and/or 656-2.

Referring to FIG. 6, the antenna array 610 may include a plurality of antenna elements, and the plurality of antenna elements may include a first antenna element 611, a second antenna element 612, or a third antenna element 613. Each of the antenna elements may include feed points of H-pols 611-1, 612-1, and 613-1 and V-pols 611-2, 612-2, and 613-2.

Referring to FIG. 6, an IF H signal may be synthesized with an F_{LO} signal through a first mixer 623-1 and input to the first splitter/combiner 631. The signal input to the first splitter/combiner 631 may be divided into N signals and transmitted to the first phase shifter 641, the third phase shifter 643, or the fifth phase shifter 645. The signals whose phases are shifted by the respective phase shifters 641, 643, and 645 may be amplified by the PAs 651-1, 653-1, and 655-1 and then transmitted to the radio space through the H-pols 611-1, 612-1, and 613-1. An IF V signal may be synthesized with an F_{LO} signal through the second mixer 623-2 and input to the second splitter/combiner 632. The signal input to the second splitter/combiner 632 may be divided into N signals and transmitted to the second phase shifter 642, the fourth phase shifter 644, or the sixth phase shifter 646. The signals whose phases are shifted by the respective phase shifters 642, 644, and 646 may be amplified by the PAs 652-1, 654-1, and 656-1 and then transmitted to the radio space through the V-pols 611-2, 612-2, and 613-2.

According to an embodiment, signals received through the H-pols 611-1, 612-1, and 613-1 may be amplified by the LNAs 651-2, 653-2, and 655-2 and then transmitted to the first phase shifter 641, the third phase shifter 643, or the fifth phase shifter 645. The signals whose phases are shifted by the phase shifters 641, 643, and 645 may be synthesized in the first splitter/combiner 631 and transmitted to the first mixer 623-1. The first mixer 623-1 may receive a signal combined by the first splitter/combiner 631 and synthesize the same with an F_{LO} signal, thereby outputting an IF H signal. Signals received through the V-pols 611-2, 612-2, and 613-2 may be amplified by the LNAs 652-2, 654-2, and 656-2 and then transmitted to the second phase shifter 642, the fourth phase shifter 644, or the sixth phase shifter 646. The signals whose phases are shifted by the phase shifters 642, 644, and 646 may be combined in the second splitter/combiner 632 and transmitted to the second mixer 623-2. The second mixer 623-2 may receive the signal combined by the second splitter/combiner 632 and synthesize the same with an F_{LO} signal, thereby outputting an IF V signal. The IF H signal and the IF V signal may be transmitted to an IFIC (e.g., the IFIC 430 in FIG. 4). The IFIC may convert the IF signal into a baseband signal and transmit the same to a communication processor (e.g., the communication processor 420 in FIG. 4).

According to an embodiment, a far-field loopback system may be used to test whether the RFIC 620 included in the millimeter wave module in FIG. 6 is defective using an on-the-air (OTA) verification system. The millimeter wave module (e.g., the antenna module 197 in FIG. 1 or the third antenna module 246 in FIG. 2A) may be manufactured in an antenna-in-package (AiP) form in which the antenna array 610 and the RFIC 620 are integrated, so it may be difficult to make a separate external connection port for measuring the performance of the RFIC itself excluding the antenna. According to an embodiment, when a module is manufactured, a failure judgement inspection for RF characteristics may be performed by configuring an environment in which a millimeter wave module is able to radiate a signal in a chamber of a far-field loopback inspection system.

The far-field loopback method may be inefficient in cost, space, or time because it involves installation of a huge far-field chamber in the millimeter wave module manufacturing line and use of relatively expensive equipment to apply 5G signals. According to an embodiment, the millimeter wave module may be inspected for defects by forming its own loopback path using the H-pole and V-pole of a patch antenna provided in the millimeter wave module, instead of the far-field loopback method.

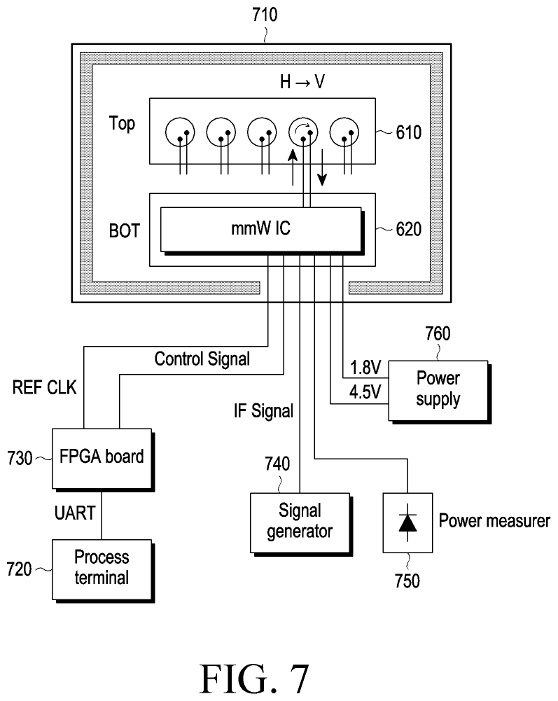

FIG. 7 illustrates a self-loopback inspection system, according to an embodiment of the disclosure. Referring to FIG. 7, a millimeter wave module (e.g., a module in which the antenna array 610 and the RFIC 620 are integrated) may be disposed in a shielding jig 710 serving as a chamber, and the millimeter wave module may perform signal analysis by a self-loopback method by itself. For example, the IF signal generated by a signal generator 740 may be input to an input terminal of the RFIC 620 of the millimeter wave module disposed inside the shielding jig 710. The power supply 760 may supply power of a configured voltage (e.g., 1.8V or 4.5V) to the millimeter wave module. A process terminal 720 may transmit a control signal to a field programmable gate array (FPGA) board 730 through a universal asynchronous receiver/transmitter (UART), and the FPGA board 730 may generate a reference clock (RFE CLK) and a control signal for generating a local oscillator (LO) frequency in the millimeter wave module and input the same to an input terminal of the RFIC 620.

The IF signal input to the RFIC 620 of the millimeter wave module may be converted into an RF signal and then radiated through a specific H-pole of the antenna array 610. At least a part of the signal radiated through the H-pol may be input through a specific V-pol. The signal input through the specific V-pol may be converted into an IF signal by the RFIC 620. A power measurer 750 may measure the magnitude of the received signal converted to the IF signal, thereby determining defects in the RFIC.

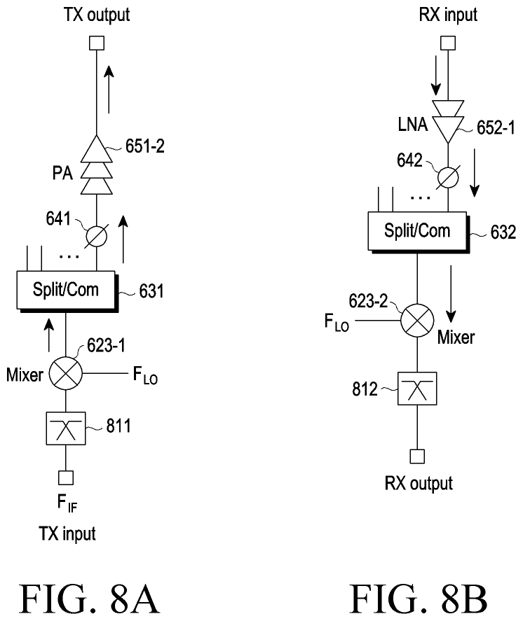

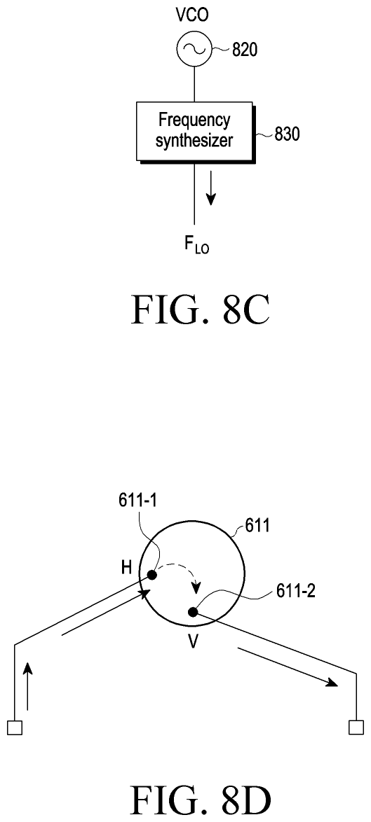

The millimeter wave module disposed in the shielding jig 710 may be configured as shown in FIG. 6, and the millimeter wave module may be classified into respective hardware components shown in FIGS. 8A to 8D. FIG. 8A illustrates a TX chain inside a millimeter wave module, according to embodiment of the disclosure. FIG. 8B illustrates an RX chain inside a millimeter wave module, according to embodiment of the disclosure. FIG. 8C illustrates a frequency synthesizer inside a millimeter wave module, according to an embodiment of the disclosure. FIG. 8D illustrates an antenna inside a millimeter wave module, according to an embodiment of the disclosure.

Referring to FIG. 8A, a TX chain of the RFIC 620 may include a first diplexer 811, a mixer 623-1, a splitter/combiner 631, a phase shifter 641, or a PA 651-2. Referring to FIG. 8B, the RX chain of the RFIC 620 may include an LNA 652-1, a phase shifter 642, a splitter/combiner 632, a mixer 623-2, or a second diplexer 812. Referring to FIG. 8C, a VCO signal 820 may be synthesized in frequency through a frequency synthesizer 830 to output a F_{LO} frequency signal. Referring to FIG. 8D, an antenna element 611 included in the antenna array 610 may include feed points such as a H-pol 611-1 and a V-pol 611-2.

It may be identified whether or not the frequency synthesizer 830 in the millimeter wave module in FIGS. 8A, 8B, 8C, and 8D is defective by a status flag to determine whether or not a phase-locked-loop (PLL) (e.g., the PLL 621 in FIG. 6) included in the frequency synthesizer 830 is locked.

According to an embodiment, it may be determined whether or not the TX chain in FIG. 8A is defective by applying a signal in the IF frequency band from the outside of an IF input terminal and then measuring the power of an RF band signal at a TX output terminal. For example, if any one of the elements included in the TX chain is defective, the magnitude of a TX signal output from a final TX output terminal may fall outside of a normal range, thereby identifying whether or not there is a defect. It may be determined whether or not the RX chain in FIG. 8B is defective by applying a signal in the RF (mmWave) frequency band from the outside to an RX input terminal and then measuring the magnitude of an IF band signal at the RX output terminal. It may be determined whether or not the antenna array in FIG. 8D is defective by applying a signal to the H/V pol and then identifying whether the antenna normally radiates a signal.

According to an embodiment, it is impossible to individually determine defects of respective elements in the case where HW components constituting the millimeter wave module in FIGS. 8A, 8B, 8C, and 8D are integrated in a single AiP module, and the defects may be collectively determined in a situation where the hardware elements in the millimeter wave module operate complexly.

For example, the defect inspection method based on the far-field loopback method may determine the characteristics of both the TX chain in FIG. 8A and the antenna array in FIG. 8D during the TX measurement. In addition, the characteristics of both the RX chain in FIG. 8B and the antenna array in FIG. 8D may be determined during the RX measurement. The defect judgement criterion of the far-field loopback method may be calculated in consideration of a variation range between each hardware element and a good product.

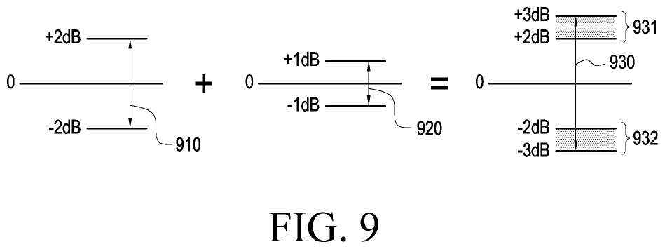

For example, referring to FIG. 9, if a good-product variation range 910 of the RX chain is +/−2 dB and if a good-product variation range 920 of an ANT gain is +/−1 dB, a good-product judgement range 930 may be determined to be +/−3 dB in order to cover the good products of respective elements, as shown in the drawing, during the defect judgment inspection of an RX path in the module state. However, if a good-product inspection is performed based on the above criteria, some defective samples among the samples 931 whose Rx chain values are +2 to +3 dB from the average value or samples 932 whose Rx chain values are −2 to −3 dB there from may be misjudged as good products depending on the distribution of the ANTs inspected together. This indicates the deterioration in detection capability, which occurs in a situation where all hardware elements are inevitably inspected complexly, instead of being inspected at once. According to an embodiment, the self-loopback method shown in FIG. 7 may exhibit a greater detection capability degradation than that shown in FIG. 9, compared to the above-described far-field loopback method.

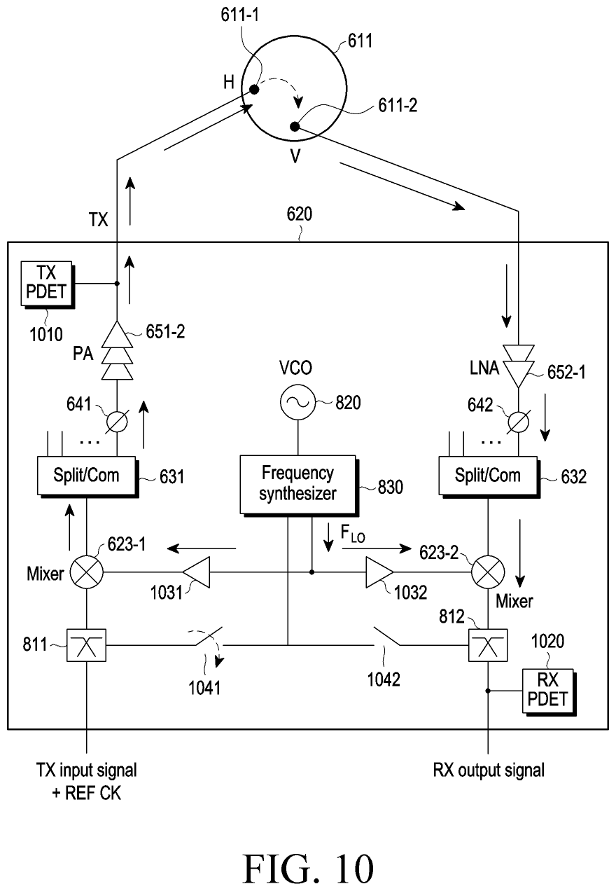

FIG. 10 illustrates a self-loopback inspection system, according to an embodiment of the disclosure. Referring to FIG. 10, when a TX signal is applied in an IF frequency band from the outside of the module, the signal may be converted to an RF frequency band via a TX chain inside the RFIC 620, may pass through the phase shifter 641, and may be amplified by the PA 651-2. The amplified signal may be applied to an H-pol (or V-pol) of the array antenna, and a signal attenuated by a coupling factor (CF) compared to the applied signal may be input to a V-pol of the array antenna. The coupling factor may be defined as the amount of coupling between the H-pole and the V-pole of the array antenna. The signal input to the V-pol may be applied to an RX input terminal of the RFIC 620 and converted into an IF frequency band while passing through an RX chain of the RFIC 620 to be output as an RX output signal.

According to an embodiment, a sum of all performance factors (e.g., a transmission gain or TX chain gain (G_{TX}), a reception gain or RX chain gain (G_{RX}), and a coupling factor (Ant CF) to determine whether the antenna gain is abnormal) of hardware elements may be identified from a loopback gain obtained by the far-field loopback method, as shown in Equation 1 below.

Loopback gain=IF_Out_Pwr-IF_In_P_wr=G_{TX}+Ant CF+G_{RX} [Equation 1]

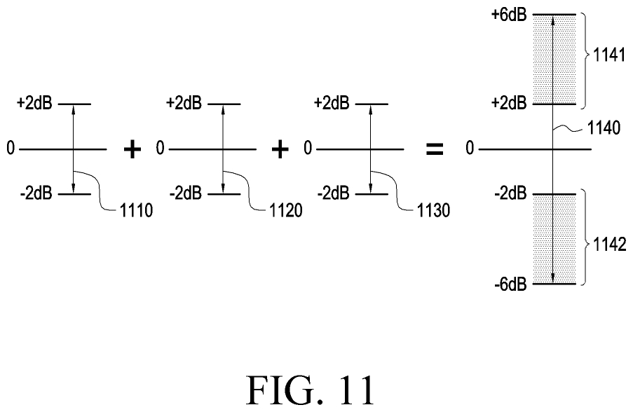

As described above, in order to determine defects using only the loopback gain value in Equation 1, a defect criterion may be configured to include all good-product variation ranges of hardware elements. For example, determination of defects using a loopback gain may be represented as shown in FIG. 11. Referring to FIG. 11, in the case of the self-loopback inspection, if a gain variation 1110 of the TX chain is +/−2 dB, if a gain variation 1120 of an RX chain is +/−2 dB, and if a coupling factor variation 1130 of an antenna is +/−2 dB, a good-product judgement criterion 1140 of the loopback gain may be determined to be +/−6 dB. In this case, considering only the RX chain, some defective samples among the samples in the range 1141 of +2 to +6 dB and in the range 1142 of −2 to −6 dB may be misjudged as good products. The self-loopback inspection in FIG. 11 above has a wider misjudgement range than the far-field loopback method in FIG. 9, relatively lowering the detection capability.

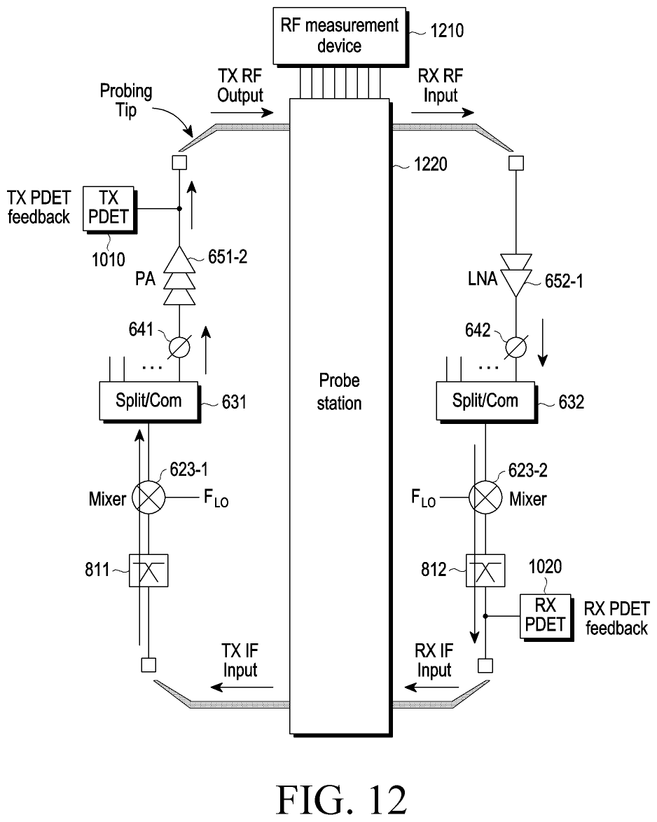

Hereinafter, a millimeter wave inspection method according to an embodiment will be described with reference to FIGS. 12 to 18. According to an embodiment, in order to prevent the deterioration of detection capability caused by the self-loopback method, inspection may be performed using an automated test equipment (ATE) inspection result of an RFIC. Although the above inspection method may be referred to as an ATE-based self-loopback inspection method, an embodiment is not limited to the specific term. According to an embodiment, when an RFIC is manufactured, an ATE inspection may be performed to identify basic performance of an IC in a wafer state.

FIG. 12 is a diagram illustrating a data flow of a method for obtaining a TX chain gain and an RX chain gain of an RFIC, according to an embodiment of the disclosure. Referring to FIG. 12, during the ATE inspection, a signal may be applied to a TX input and power of a TX output may be measured, and a signal may be applied to an RX input and power of an RX output may be measured, using an RF measurement device 1210 and a probe station 1220. A TX chain gain (G_{TX}) and an RX chain gain (G_{RX}) inside the RFIC may be obtained using the measured data. The obtained TX chain gain and RX chain gain may be stored in a memory inside the RFIC 620.

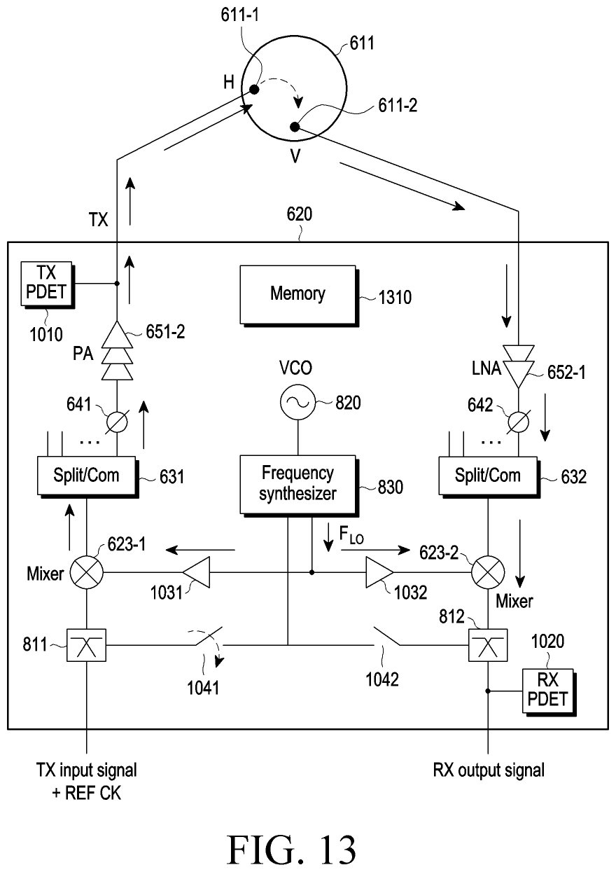

FIG. 13 illustrates a self-loopback inspection system, according to another embodiment of the disclosure. Referring to FIG. 13, the TX chain gain and the RX chain gain obtained during the ATE inspection in FIG. 12 may be stored in a memory 1310 (e.g., one-time programmable (OTP) memory).

According to an embodiment, after a millimeter wave module is manufactured, the ATE-based self-loopback inspection may be performed using the information stored in the memory, thereby improving detection capability. For example, an IF frequency may be applied to an input terminal of the millimeter wave module, and an IF frequency signal that is output by loopback may be measured, and a G_{TX} or G_{RX} value, which was measured and stored during the ATE inspection may be loaded from the memory 1310 inside the RFIC 620. According to an embodiment, a coupling factor (CF_calc) may be calculated based on the loaded information and measured value as shown in Equation 2 below, thereby determining defects of the RFIC, based on the coupling factor.

CF_calc=IF_Out_Pwr-IF_In_Pwr-G_{TX}-G_{RX} [Equation 2]

The relationship between signals output by loopback through the millimeter wave module according to the above method may be expressed as shown in Equation 3 below.

CF=IF_Out_Pwr-IF_In_Pwr-(G_{TX}+TX Corr Factor+TX Error)−(G_{RX}+RX Corr Factor+RX Error) [Equation 3]

In Equation 3 above, CF is a coupling factor of an antenna and may have, for example, a variation of +/−2 dB. G_{TX} denotes a gain value of the Tx chain measured and stored in the memory 1310 during the ATE in FIG. 12, and G_{RX} denotes a gain value of the Rx chain measured and stored in the memory 1310 during the ATE in FIG. 12. TX Corr Factor may indicate a TX correction factor that changes when the RFIC is assembled inside the module and connected to the antenna array 610, and may be identified as a static value. TX Error represents a TX gain variation for each module caused by a variation between modules of an antenna voltage standing-wave ratio (VSWR). RX Corr Factor may indicate an RX correction factor that changes when the RFIC 620 is assembled inside the millimeter wave module and connected to the array antenna, and may be identified as a static value. RX Error represents an RX gain variation for each module caused by a variation between modules of an antenna VSWR.

According to an embodiment, in the ATE-based loopback inspection method, it is possible to identify the TX chain gain and/or the RX chain gain for each RFIC through the memory 1310, and to identify the TX correction factor and the RX correction factor as static values. By identifying the TX chain gain and the RX chain gain, the factor causing the difference between respective millimeter wave modules is only the gain variations of the TX chain/RX chain caused by the difference in VSWR value for each antenna included in the module. This may exhibit a much smaller range (e.g., +/−0.5 dB) than the existing chain gain variation (e.g., about +/−2 dB). Considering this, a variation factor of CF_Calc may be derived as shown in Equation 4 below.

CF_Calc=CF+TX Corr Factor(Static)+TX Error+RX Corr Factor(Static)+RX Error [Equation 4]

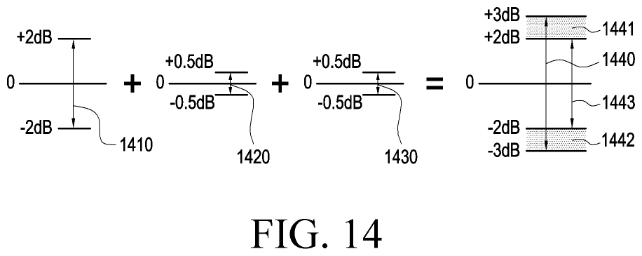

A defect judgement criterion and a misjudgement range of the ATE-based self-loopback method may be expressed as shown in FIG. 14, based on Equation 4 above. Referring to FIG. 14, in the case of the self-loopback inspection, if a gain variation 1410 of the antenna CF is +/−2 dB, if a gain variation 1420 of TX Error is +/−0.5 dB, and if a gain variation 1430 of RX Error is +/−0.5 dB, a good-product judgement criterion 1440 of the loopback gain may be determined to be +/−3 dB. In this case, a good-product distribution area 1443 of the antenna CF is +/−2 dB, and some defective samples among the samples corresponding to the range 1441 of +2 to +3 dB and the range 1442 of −2 to −3 dB may be misjudged as good products. It may be seen that the self-loopback inspection in FIG. 14 according to an embodiment has a relatively improved detection capability, compared to the self-loopback inspection method described in FIG. 11.

According to an embodiment, detection capability may be improved using a TX Power Detector (PDET) 1010 or RX PDET 1020 at a PA output terminal in the TX chain. For example, if a correlation factor (pcorr) value between the actual power output from the TX chain and a detection code value read from TX PDET 1010 is found from the values thereof and then stored in the memory 1310 during the ATE inspection, it is possible to reduce the uncertainty caused by the good-product variation of the TX chain gain in detecting the gain deterioration phenomenon due to defects/distortion of antenna characteristics, which may occur when the RFIC 620 is integrated into the millimeter wave module.

For example, a method of identifying the TX gain error through the value of TX PDET 1010 may be calculated by Equation 5 below.

TX Gain Error=TX PDET+pcorr−IF_IN_Pwr−G_{TX} [Equation 5]

According to an embodiment, when the TX Gain Error value calculated by Equation 5 above falls inside a configured range, the millimeter wave module may be determined to be good.

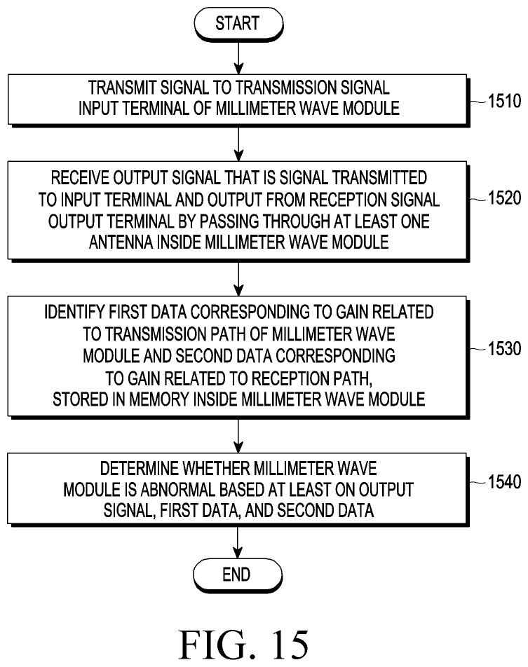

Hereinafter, an operation method of an electronic device according to an embodiment will be described with reference to FIGS. 15 to 18.

FIG. 15 is a flowchart illustrating a method of inspecting a millimeter wave module by an electronic device, according to an embodiment of the disclosure. Referring to FIG. 15, according to an embodiment, an electronic device (e.g., an inspection device) (e.g., the electronic devices 101 and 102 in FIG. 1) may transmit a signal to a transmission signal input terminal of a millimeter wave module (e.g., the antenna module 197 in FIG. 1 or the third antenna module 246 in FIG. 2A) in operation 1510.

According to an embodiment, in operation 1520, the electronic device may receive an output signal that is the signal transmitted to the transmission signal input terminal and output from a reception signal output terminal of the millimeter wave module by passing through at least one antenna inside the millimeter wave module.

According to an embodiment, in operation 1530, the electronic device may identify first data corresponding to a gain (Tx chain gain) related to a transmission path of the millimeter wave module and second data corresponding to a gain (Rx chain gain) related to a reception path, which is stored in a memory inside the millimeter wave module.

According to an embodiment, in operation 1540, the electronic device may determine whether or not the millimeter wave module is abnormal based at least on the output signal, the first data, and the second data. For example, the electronic device may determine whether or not the millimeter wave module is abnormal using Equation 3 and Equation 4 described above.

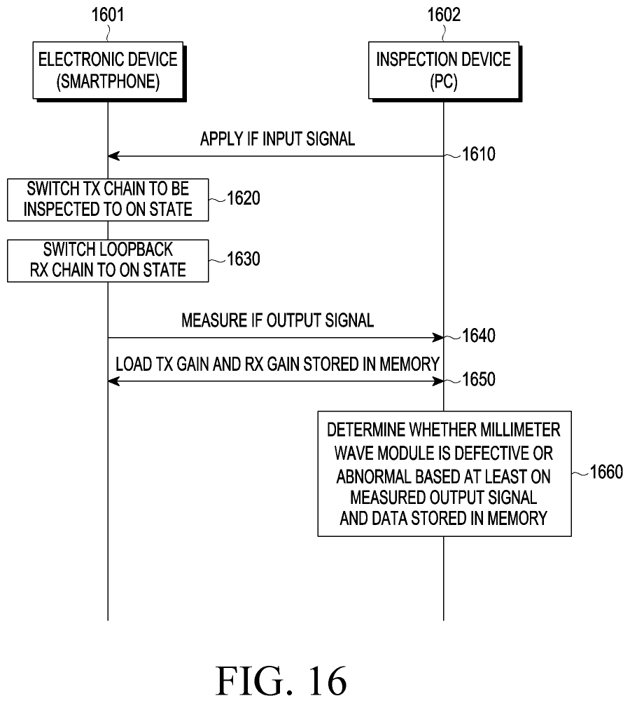

FIG. 16 is a sequence diagram illustrating an method of inspecting a millimeter wave module by an electronic device, according to an embodiment of the disclosure. Referring to FIG. 16, according to an embodiment, an inspection device 1602 (e.g., the electronic devices 101 and 102 in FIG. 1) may apply an IF input signal to a transmission signal input terminal of a millimeter wave module (e.g., the antenna module 197 in FIG. 1 or the third antenna module 246 in FIG. 2A) of an electronic device 1601 (e.g., the electronic device 101 in FIG. 1) in operation 1610.

According to an embodiment, the electronic device 1601 may switch a transmission chain (TX chain) to be inspected, among a plurality of transmission chains, to an on state in operation 1620. For example, the plurality of transmission chains may sequentially switch to the on state for inspection. In operation 1630, the electronic device 1601 may switch a loopback reception chain (RX chain) to an on state. According to an embodiment, the IF input signal input to the transmission signal input terminal of the electronic device 1601 may be output from a reception signal output terminal of the millimeter wave module by passing through a transmission chain, at least one antenna, and a reception chain inside the millimeter wave module.

According to an embodiment, the inspection device 1602 may measure an IF output signal output from the reception signal output terminal in operation 1640.

According to an embodiment, the inspection device 1602, in operation 1650, may load and identify first data corresponding to a gain (Tx chain gain) related to a transmission path of the millimeter wave module and second data corresponding to a gain (Rx chain gain) related to a reception path, which is stored in a memory inside the millimeter wave module of the electronic device 1601.

According to an embodiment, the inspection device 1602 may determine whether the millimeter wave module is defective or abnormal based at least on the measured IF output signal, the first data, and the second data in operation 1660. For example, the electronic device may determine whether or not the millimeter wave module is abnormal using Equation 3 and Equation 4 described above.

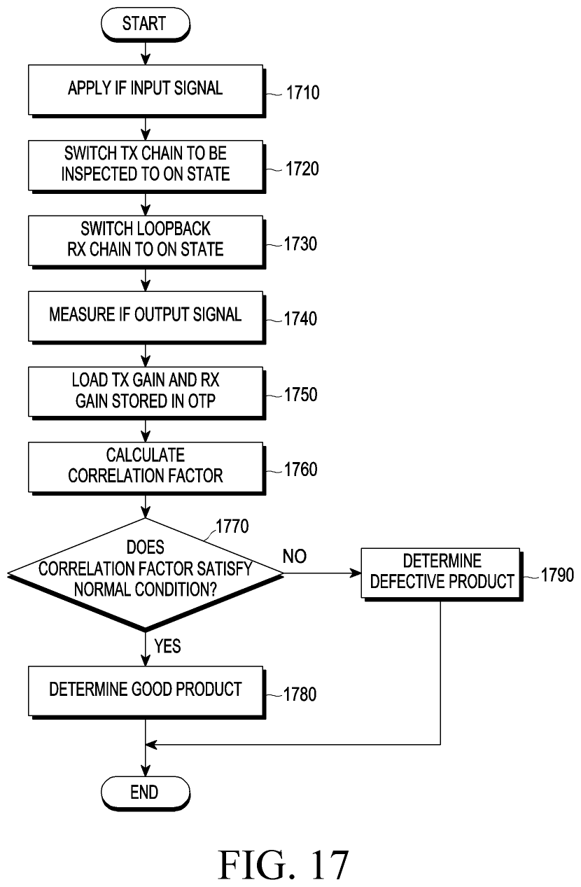

FIG. 17 is a flowchart illustrating a method of inspecting a millimeter wave module by an electronic device, according to another embodiment of the disclosure. Referring to FIG. 17, according to an embodiment, an inspection device 1602 (e.g., the electronic devices 101 and 102 in FIG. 1) may apply an IF input signal to a transmission signal input terminal of a millimeter wave module (e.g., the antenna module 197 in FIG. 1 or the third antenna module 246 in FIG. 2A) of the electronic device 1601 (e.g., the electronic device 101 in FIG. 1) in operation 1710.

According to an embodiment, in operation 1720, the inspection device 1602 may input a control signal to the electronic device 1601 such that a transmission chain (TX chain) to be inspected, among a plurality of transmission chains included in the millimeter wave module of the electronic device 1601, switches to an on state. For example, the plurality of transmission chains may be controlled to sequentially switch to the on state for inspection. In operation 1730, the inspection device 1602 may input a control signal to the electronic device 1601 such that a loopback reception chain (RX chain) included in the millimeter wave module of the electronic device 1601 switches to an on state. According to an embodiment, the IF input signal input to the transmission signal input terminal of the electronic device 1601 may be output from a reception signal output terminal of the millimeter wave module by passing through a transmission chain, at least one antenna, and a reception chain inside the millimeter wave module.

According to an embodiment, the inspection device 1602 may measure the IF output signal output from the reception signal output terminal in operation 1740.

According to an embodiment, the inspection device 1602, in operation 1750, may identify first data corresponding to a gain (Tx chain gain) related to a transmission path of the millimeter wave module and second data corresponding to a gain (Rx chain gain) related to a reception path, which is stored in a memory (e.g., OTP) inside the millimeter wave module of the electronic device 1601.

According to an embodiment, the inspection device 1602 may calculate a coupling factor, based at least on the measured IF output signal, the first data, and the second data, in operation 1760. For example, the inspection device 1602 may calculate the coupling factor according to Equation 3 and Equation 4 described above.

According to an embodiment, in operation 1770, the inspection device 1602 may identify whether or not the calculated coupling factor satisfies a normal condition (e.g., falls within a normal range). As a result of the identification, if the coupling factor does not satisfy the normal condition (NO in operation 1770), the inspection device 1602 may determine that the millimeter wave module of the electronic device 1601 is defective in operation 1790. As a result of the identification, if the coupling factor satisfies the normal condition (YES in operation 1770), the inspection device 1602 may determine the millimeter wave module of the electronic device 1601 to be a good product in operation 1780.

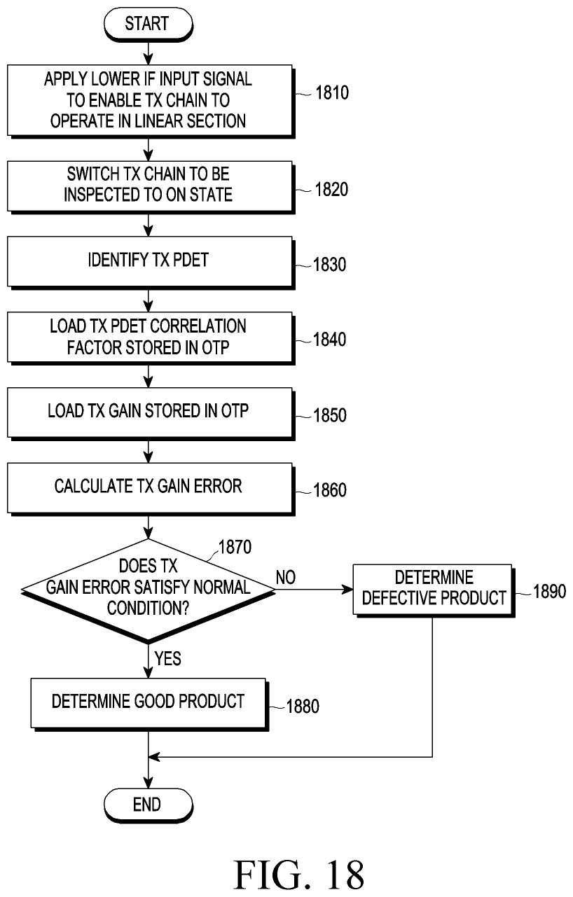

FIG. 18 is a flowchart illustrating a method of inspecting a millimeter wave module by an electronic device, according to yet another embodiment of the disclosure. Referring to FIG. 18, according to an embodiment, an inspection device 1602 (e.g., the electronic devices 101 and 102 in FIG. 1) may apply an IF input signal to a transmission signal input terminal of a millimeter wave module (e.g., the antenna module 197 in FIG. 1 or the third antenna module 246 in FIG. 2A) of the electronic device 1601 (e.g., the electronic device 101 in FIG. 1) in operation 1810. For example, the IF input signal may be a signal of relatively low power to enable the TX chain in the millimeter wave module to operate in a linear section.

According to an embodiment, in operation 1820, the inspection device 1602 may input a control signal to the electronic device 1601 such that a transmission chain (TX chain) to be inspected, among a plurality of transmission chains included in the millimeter wave module of the electronic device 1601, switches to an on state. For example, the plurality of transmission chains may be controlled to sequentially switch to the on state for inspection.

According to an embodiment, in operation 1830, the inspection device 1602 may identify the power of the transmission output signal input to at least one antenna via the transmission chain, which is in the on state inside the millimeter wave module of the electronic device 1601, through a transmission output signal judgement terminal (TX PDET).

According to an embodiment, the inspection device 1602 may identify data corresponding to a correlation factor between the value measured by the transmission output signal judgement terminal (TX PDET) and the actual output signal from the memory in operation 1840.

According to an embodiment, in operation 1850, the inspection device 1602 may identify data corresponding to a gain (Tx chain gain) related to a transmission path of the millimeter wave module from the memory inside the millimeter wave module.

According to an embodiment, the inspection device 1602 may calculate a transmission gain error, based at least on the power of the identified transmission output signal, the data corresponding to the correlation factor, and the gain related to the transmission path in operation 1860. For example, the inspection device 1602 may calculate the transmission gain error using Equation 5 described above.

According to an embodiment, in operation 1870, the inspection device 1602 may identify whether or not the calculated transmission gain error satisfies a normal condition (e.g., falls within a normal range). As a result of the identification, if the transmission gain error does not satisfy the normal condition (NO in operation 1870), the inspection device 1602 may determine that the millimeter wave module (e.g., a corresponding transmission change of the millimeter wave module) of the electronic device 1601 is defective in operation 1890. As a result of the identification, if the transmission gain error satisfies the normal condition (YES in operation 1870), the inspection device 1602 may determine the millimeter wave module (e.g., a corresponding transmission chain of the millimeter wave module) of the electronic device 1601 to be good in operation 1880.

A millimeter wave module inspection system according to any one of an embodiment may include an electronic device (e.g., the electronic device 102 in FIG. 1 or the inspection device 1602 in FIG. 16) including at least one processor and a millimeter wave module (mmWave module) (e.g., the third antenna module 246 in FIG. 2A) including a memory (e.g., the memory 1310 in FIG. 13), at least one antenna (e.g., the antenna array 610 in FIG. 6), and at least one transceiver (e.g., the RFIC 620 in FIG. 6), wherein the processor of the electronic device may control an input signal to be input to a transmission signal input terminal of the millimeter wave module, identify an output signal that is output from a reception signal output terminal of the millimeter wave module when the input signal passes through the at least one antenna in the millimeter wave module, identify first data corresponding to a gain (Tx chain gain) related to a transmission path of the millimeter wave module stored in the memory and second data corresponding to a gain (Rx chain gain) related to a reception path of the millimeter wave module stored in the memory, and determine whether or not the millimeter wave module is abnormal based at least on the identified output signal, the first data, and the second data.

According to an embodiment, the first data or the second data may include data measured in a process of manufacturing a radio frequency integrated circuit (RFIC) included in the millimeter wave module.

According to an embodiment, the processor of the electronic device may identify a coupling factor of an antenna of the millimeter wave module, based at least on the identified output signal, the first data, and the second data, and determine whether or not the millimeter wave module is abnormal based on the identified coupling factor.

According to an embodiment, the processor of the electronic device may determine whether or not the millimeter wave module is abnormal based at least on a signal detected at an output terminal of a power amplifier included in a transmission circuit of the millimeter wave module.

According to an embodiment, the processor of the electronic device may control a reference clock for generating a local oscillator (LO) frequency used in the millimeter wave module to be input to the input terminal of the millimeter wave module.

An electronic device (e.g., the electronic device 101 or 102 in FIG. 1) according to any one of an embodiment may include a communication interface (e.g., the communication module 190 or the interface 177 in FIG. 1), a processor (e.g., the processor 120 in FIG. 1) operatively connected to the communication interface, and/or a memory (e.g., the memory 130 in FIG. 1) operatively connected to the processor, wherein the memory may store instructions that, when executed by the processor of the electronic device, cause the electronic device to transmit, through the communication interface, a signal to a transmission signal input terminal of a millimeter wave module (mmWave module) (e.g., the third antenna module 246 in FIG. 2A) including at least one antenna (e.g., the antenna 248 in FIG. 2A) and at least one transceiver (e.g., the third RFIC 226 in FIG. 2A), receive, through the communication interface, an output signal that is when the input signal passes through the at least one antenna in the millimeter wave module, output from a reception signal output terminal, identify first data corresponding to a gain (Tx chain gain) related to a transmission path of the millimeter wave module stored in a memory in the millimeter wave module and second data corresponding to a gain (Rx chain gain) related to a reception path of the millimeter wave module stored in the memory in the millimeter wave module, and determine whether or not the millimeter wave module is abnormal based at least on the identified output signal, the first data, and the second data.

According to an embodiment, the first data or the second data may include data measured in a process of manufacturing a radio frequency integrated circuit (RFIC) included in the millimeter wave module.

According to an embodiment, the processor may identify a coupling factor of an antenna of the millimeter wave module, based at least on the identified output signal, the first data, and the second data, and determine whether or not the millimeter wave module is abnormal based on the identified coupling factor.

According to an embodiment, the processor may determine whether or not the millimeter wave module is abnormal based at least on a signal detected at an output terminal of a power amplifier included in a transmission circuit of the millimeter wave module.

According to an embodiment, the processor may control a reference clock for generating a local oscillator (LO) frequency used in the millimeter wave module to be input to the input terminal of the millimeter wave module.

A millimeter wave module inspection method according to any one of an embodiment may include inputting an input signal to a transmission signal input terminal of a millimeter wave module, identifying an output signal that is output from a reception signal output terminal of the millimeter wave module when the input signal passes through at least one antenna in the millimeter wave module, identifying first data corresponding to a gain (Tx chain gain) related to a transmission path of the millimeter wave module stored in a memory in the millimeter wave module and second data corresponding to a gain (Rx chain gain) related to a reception path of the millimeter wave module stored in the memory in the millimeter wave module, and determining whether or not the millimeter wave module is abnormal based at least on the identified output signal, the first data, and the second data.

According to an embodiment, the first data or the second data may include data measured in a process of manufacturing a radio frequency integrated circuit (RFIC) included in the millimeter wave module.

According to an embodiment, the method may include identifying a coupling factor of an antenna, based at least on the identified output signal, the first data, and the second data, and determining whether or not the millimeter wave module is abnormal based on the identified coupling factor.

According to an embodiment, the method may include determining whether or not the millimeter wave module is abnormal based at least on a signal detected at an output terminal of a power amplifier included in a transmission circuit of the millimeter wave module.

According to an embodiment, the method may further include inputting a reference clock for generating a local oscillator (LO) frequency used in the millimeter wave module to the input terminal of the millimeter wave module.

A millimeter wave module inspection method according to any one of an embodiment may include inputting an input signal to a transmission signal input terminal of a millimeter wave module, performing control such that a transmission chain to be inspected switches to an on state, identifying an output signal that is output from a reception signal output terminal of the millimeter wave module when the input signal passes through at least one antenna in the millimeter wave module, identifying first data corresponding to a gain (Tx chain gain) related to a transmission path of the millimeter wave module stored in a memory in the millimeter wave module and second data corresponding to a gain (Rx chain gain) related to a reception path of the millimeter wave module stored in the memory in the millimeter wave module, and determining whether or not the millimeter wave module is abnormal based at least on the identified output signal, the first data, and the second data.

According to an embodiment, the first data or the second data may include data measured in a process of manufacturing a radio frequency integrated circuit (RFIC) included in the millimeter wave module.

According to an embodiment, the method may include identifying a coupling factor of an antenna, based at least on the identified output signal, the first data, and the second data, and determining whether or not the millimeter wave module is abnormal based on the identified coupling factor.

According to an embodiment, the method may include determining the millimeter wave module to be good if the identified coupling factor satisfies a preconfigured normal condition.

According to an embodiment, the method may further include inputting a reference clock for generating a local oscillator (LO) frequency used in the millimeter wave module to the input terminal of the millimeter wave module.

A millimeter wave module inspection method according to any one of an embodiment may include inputting an input signal to a transmission signal input terminal of a millimeter wave module, performing control such that a transmission path to be inspected switches to an on state, identifying, through a transmission output signal judgement terminal (TX PDET), power of a transmission output signal that is the input signal passing through the transmission path inside the millimeter wave module and input to at least one antenna, identifying first data corresponding to a gain (Tx chain gain) related to a transmission path of the millimeter wave module from a memory inside the millimeter wave module, identifying second data corresponding to correlation factor between a value measured by the transmission output signal judgement terminal (TX PDET) and an actual output signal from the memory, and determining whether or not the transmission path is abnormal based at least on the identified transmission output signal power, the first data, and the second data.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A millimeter wave module inspection system comprising:
an electronic device comprising at least one processor; and
a millimeter wave module comprising a memory, at least one antenna, and at least one transceiver,
wherein the at least one processor is configured to:
control an input signal to be input to a transmission signal input terminal of the millimeter wave module;
identify an output signal that is output from a reception signal output terminal of the millimeter wave module when the input signal passes through the at least one antenna of the millimeter wave module;
identify first data corresponding to a transmission chain gain related to a transmission path of the millimeter wave module stored in the memory and second data corresponding to a reception chain gain related to a reception path of the millimeter wave module, the first data and the second data being stored in the memory; and
determine whether the millimeter wave module is abnormal based at least on the identified output signal, the first data, and the second data.

2. The millimeter wave module inspection system of claim 1, wherein at least one of the first data or the second data comprises data measured in a process of manufacturing a radio frequency integrated circuit included in the millimeter wave module.

3. The millimeter wave module inspection system of claim 1, wherein the at least one processor is further configured to:
identify a coupling factor of an antenna of the millimeter wave module, based at least on the identified output signal, the first data, and the second data; and
determine whether the millimeter wave module is abnormal based on the identified coupling factor.

4. The millimeter wave module inspection system of claim 1, wherein the at least one processor is further configured to determine whether the millimeter wave module is abnormal based at least on a signal detected at an output terminal of a power amplifier included in a transmission circuit of the millimeter wave module.

5. The millimeter wave module inspection system of claim 1, wherein the at least one processor is further configured to control a reference clock for generating a local oscillator frequency used in the millimeter wave module to be input to the transmission signal input terminal of the millimeter wave module.

6. An electronic device comprising:
a communication interface;
a memory storing instructions; and
at least one processor operatively connected to the communication interface and the memory,
wherein the at least one processor is configured to execute the instructions to:
transmit, through the communication interface, an input signal to a transmission signal input terminal of a millimeter wave module comprising at least one antenna and at least one transceiver;
receive, through the communication interface, an output signal that is output from a reception signal output terminal of the millimeter wave module when the input signal passes through the at least one antenna of the millimeter wave module;
identify first data corresponding to a transmission chain gain related to a transmission path of the millimeter wave module stored in a memory of the millimeter wave module and second data corresponding to a reception chain gain related to a reception path of the millimeter wave module, the first data and the second data being stored in the memory of the millimeter wave module; and
determine whether the millimeter wave module is abnormal based at least on the identified output signal, the first data, and the second data.

7. The electronic device of claim 6, wherein at least one of the first data or the second data comprises data measured in a process of manufacturing a radio frequency integrated circuit included in the millimeter wave module.

8. The electronic device of claim 6, wherein the at least one processor is further configured to:
identify a coupling factor of an antenna of the millimeter wave module, based at least on the identified output signal, the first data, and the second data; and
determine whether the millimeter wave module is abnormal based on the identified coupling factor.

9. The electronic device of claim 6, wherein the at least one processor is further configured to determine whether the millimeter wave module is abnormal based at least on a signal detected at an output terminal of a power amplifier included in a transmission circuit of the millimeter wave module.

10. The electronic device of claim 6, wherein the at least one processor is further configured to control a reference clock for generating a local oscillator frequency used in the millimeter wave module to be input to the transmission signal input terminal of the millimeter wave module.

11. A millimeter wave module inspection method comprising:
inputting an input signal to a transmission signal input terminal of a millimeter wave module;
identifying an output signal that is output from a reception signal output terminal of the millimeter wave module when the input signal passes through at least one antenna of the millimeter wave module;
identifying first data corresponding to a transmission chain gain related to a transmission path of the millimeter wave module stored in a memory of the millimeter wave module and second data corresponding to a reception chain gain related to a reception path of the millimeter wave module, the first data and the second data being stored in the memory of the millimeter wave module; and
determining whether the millimeter wave module is abnormal based at least on the identified output signal, the first data, and the second data.

12. The millimeter wave module inspection method of claim 11, wherein at least one of the first data or the second data comprises data measured in a process of manufacturing a radio frequency integrated circuit included in the millimeter wave module.

13. The millimeter wave module inspection method of claim 11, further comprising:
identifying a coupling factor of an antenna of the millimeter wave module, based at least on the identified output signal, the first data, and the second data; and
determining whether the millimeter wave module is abnormal based on the identified coupling factor.

14. The millimeter wave module inspection method of claim 11, further comprising determining whether the millimeter wave module is abnormal based at least on a signal detected at an output terminal of a power amplifier included in a transmission circuit of the millimeter wave module.

15. The millimeter wave module inspection method of claim 11, further comprising inputting a reference clock for generating a local oscillator frequency used in the millimeter wave module to the transmission signal input terminal of the millimeter wave module.
